(19) United States
(12) Patent Application Publication
(10) Pub. No.: US 2011/0277331 A1
(43) Pub. Date: Nov. 17, 2011

(54) Crown molding ruler

(76) Inventor: Timothy J. Glomb, SR., Kennett Square, PA (US)

(21) Appl. No.: 13/067,157

(22) Filed: May 12, 2011

Related U.S. Application Data
(60) Provisional application No. 61/395,508, filed on May 14, 2010.

(51) Int. Cl. G01C 15/10

(52) U.S. Cl. 33/404

(57) ABSTRACT

The present invention provides an apparatus and method for measuring and/or marking simultaneously the projection dimension and the dropdown dimension of crown molding.

### CROSS-REFERENCE TO RELATED APPLICATIONS

This applications claims benefits of Provisional Application for Patent No. 61/395,508, filed May 14, 2011, applicant—Timothy J. Glomb, Sr., Kennett Square, Pa.

### STATEMENT REGARDING FEDERALLY SPONSORED RESEARCH OR DEVELOPMENT

“Not Applicable”

### REFERENCE TO A SEQUENCE LISTING, A TABLE, OR A COMPUTER PROGRAM, LISTING COMPACT DISC APPENDIX

“Not Applicable”

### BACKGROUND OF THE INVENTION

The present invention is directed towards a tool for use with construction projects. Although the invention may be used in many fields, it has particular relevance to the field of finish carpentry, specifically installing crown molding in a room, and will be discussed with respect thereto. Crown molding is a decorative molding used in many areas including placement along the corner of a room where the top of a wall meets the ceiling at a right angle. This area will be used for description.

Crown molding is made of wood or other synthetic material in various lengths, widths and thickness. The molding's width is positioned diagonally between the wall and ceiling and its length continues along the length of the wall, generally secured by nailing. The edges of the molding are beveled at an angle to lay flat against the wall and contact the ceiling. The face of the molding is usually planed or machined to be decorative and face toward the room. The back of the molding generally remains flat. When the molding is in position the distance from the ceiling plane down to the bottom most point of the edge of the molding is referred to as the dropdown dimension. Also when the molding is in position the distance from the wall plane to the farthest point of the edge of the molding is referred to as the projection dimension. The dropdown and projection dimensions can be found by placing a carpenter's square on the back of the molding with the square's legs protruding out past the top and bottom edges. The bottom edge of the molding should be flat against the square leg. The dimensions from the inside corner of the square to the edge of the molding correspond to the dropdown and projection dimensions from the corner where the wall and ceiling meet.

It is known in the field there are two ways to cut crown molding on a power miter saw for joining molding in inside or outside corners. One of the ways is referred to the “standup” or “nesting” position. When using this nesting position the top edge of the crown molding is placed on the miter saw table. The edge is positioned a distance from the saw fence which is also the projection dimension named previously. Most power miter saw makers provide an accessory called “crown stops” which hold the molding at the projection dimension on the saw table. Furthermore by coping the end of the molding an inside corner can be joined. Coping is trimming the end of the molding to conform to its own profile when the end is butted perpendicular against another piece. It is important that the projection point on each piece of molding is the same for the joint to fit tightly. So measuring the projection dimension and installing at the projection dimension properly is critical for completing a joint. The present invention provides for easily measuring and providing these dimensions accurately.

When installing the molding the installer usually would place a pencil mark on the wall or ceiling to designate where the molding's edge is to be positioned for securing. Using a tape measure the installer would place the end of the tape against the corner of wall and ceiling and measure down to the dropdown dimension or out to the projection dimension and place the pencil mark. The molding would be placed on these marks and secured in place. There are various methods of connecting two pieces of molding where two walls meet at a corner. It is commonly understood in the building trades that installing and joining crown molding is a most difficult and tedious task. Because of this level of difficulty it is important for these marks to be on a level plane for the molding to join its counterpart on an adjacent wall.

During the process of marking the walls a problem may arise that will result in inaccurate measuring. There are various imperfections during construction that may cause the intersecting corner of wall and ceiling to not be a right angle. Whether they are material defects or human error it is common that discrepancies exist. The plaster or compound on the wall or ceiling surface at the corner may protrude into the room beyond the general wall or ceiling plane. This would cause the true right angle intersection of the wall and ceiling planes to be buried inside the wall and ceiling surface. So when measuring and placing the mark on the defect wall or ceiling, the mark would be further out from the true position. Some installers make a jig to compensate for this problem. For example, using a piece of 1×8 wood (which measures ¾″×7¼″×10″) the installer could make such a tool. Knowing the dropdown and projection dimensions the installer would measure from the board corner and mark these dimensions on the board face along two adjoining edges. Using the same dimensions to locate an intersect point on the board face would create another corner of a rectangle opposite the first corner. This rectangle would be cut off the 1×8 work piece creating two new corners on the board. The installer would take the jig and place the new corners on the wall and ceiling and with the board perpendicular to the wall and ceiling these two new corners would correspond to the dropdown and projection dimensions with no interference from the wall and ceiling corner imperfection. The installer would place a mark where the new corners touch the wall and ceiling. However this jig will only be useful for this particular molding size. An installer would have to fabricate and store many different size jigs to work with different moldings. The present invention remedies these issues and would store compactly. A measuring scale built-in on both pieces makes it easy to see both dropdown dimension and projection dimension simultaneously. The slots in each piece make adjusting easy for a wide range of different size moldings.

It is common for construction imperfections to be present in every room of a building where crown molding is to be installed. The installer may have to twist the molding to keep it straight and to make it lay tight to the wall and ceiling. This twisting may cause the dropdown dimension and projection dimension to change from the intended position. This change in the mounting position of the molding needs to be noted because it changes the cut of the adjoining piece of molding. Once a piece of molding has been twisted in position and secured it is difficult to measure the change that occurred to the dropdown or projection dimension because the molding is in the way. The present invention is designed to measure these dimensions. The installer would place the edge of Plate 3 against the wall with scale on top edge perpendicular to wall, push Plate 3 up against the crown molding. Place top edge of Plate 2 against the ceiling with scale on edge perpendicular to the ceiling, then push Plate 2 against the crown molding. The installer would then twist the knurled nuts on the screws to tighten the plates in position. The dimensions where the measuring scales overlap correspond to the dropdown dimension and the projection dimension. The edge of Plate 2 should cross both scales of Plate 3 at the identical dimension to keep the Plate edges parallel and square. This would provide optimum dimensions but conditions may not allow for Plates to remain exactly parallel and square.

### BRIEF SUMMARY OF THE INVENTION

### Crown Molding Ruler

The present invention is to measure (in respect to the hidden true right angle corner) the dropdown dimension and the projection dimension of a piece of installed crown molding and to provide position for marking the location on the wall and ceiling for placement of crown molding.

### DESCRIPTION OF THE VIEW OF THE DRAWINGS

FIG. 1 is a frontal view of Plate 3 including two measuring scales and three slots for connection with Plate 2.

FIG. 2 is a frontal view of Plate 2 including a measuring scale and two slots for connection with Plate 3.

FIG. 3 is a top view of both Plate 2 and Plate 3 secured together with screws and knurled nuts.

FIG. 4 is a front view of Plate 2 overlapped on top of Plate 3 and secured together with two screws and knurled nuts.

FIG. 5 is a right side view of both Plate 2 and Plate 3 secured together with two screws and knurled nuts.

FIG. 6 shows Plate 2 and Plate 3 in position (against a cross section view of crown molding on the wall and ceiling) to measure the dropdown and projection dimensions.

### DESCRIPTION OF THE INVENTION

### Crown Molding Ruler

The invention is comprised of two rectangular flat plates. “Plate 3” measures 8.5″×10.25″×0.10″, it has three slots 1, 1a, 1b (0.1875″×5.5″ long) parallel to each other routed out lengthwise in the surface, and it has a 6″ long measuring scale 2 on the top edge from the left corner to the right, and a 6″ long measuring scale 2a extending from left to right just under the center of the plate. “Plate 2” measures 5″×12″×0.10″, it has two slots 1c, 1d (0.1875″×4.875″ and 0.1875″×5.125″) inline 0.625″ apart routed out lengthwise in the surface, it has a 6″ long measuring scale 2b on the left edge from the top corner down. Plate 2 is placed on top of Plate 3 with the slots perpendicular to each other. A ⅛″×½″ truss head screw 3 is placed into the top slot of Plate 3 and through the top slot of Plate 2. Another ⅛″×½″ truss head screw 3a is placed into the bottom slot of Plate 3 and through the bottom slot of Plate 2. A knurled nut 4, 4a is placed on the end of each screw for holding the plates together.

While holding Plate 3 in a horizontal position Plate 2 can be slid both horizontally and vertically. The user can position the plate edges to overlap at the scale dimensions that correspond to the dropdown 5 and projection 6 dimensions of a crown molding. While holding plates still the nut can be tightened on the screw to secure the plates from moving. The user could place the plates on the wall 8 and against the ceiling 9 to mark the location to place the edge of the crown molding 7.

While holding Plate 3 in a horizontal position Plate 2 can be slid both horizontally and vertically. The user could place Plate 3 on the wall 8 and slide up against a piece of crown molding 7, also slide Plate 2 away from wall and up against the ceiling 9, then slide Plate 2 over to contact the crown molding 7. Hold plates still then tighten knurled nut 4 on screw 3 to secure plates from moving. Pull plates down to read dimensions on scales 2, 2a, 2b that correspond to dropdown 5 and projection 6 dimensions of crown molding 7. These dimensions are used to position adjoining molding piece to be cut on the miter saw.

By placing screw 3 in the top slot 1 and screw 3a in the middle slot 1a of Plate 3 and both screws 3, 3a in the bottom slot 1d of Plate 2 the plate can be spread further apart to accommodate measuring a larger piece of crown molding 7.

While only one embodiment of the present invention has been shown and described, it is to be understood that changes in plate size and modifications to slot location to accommodate various materials or articles may be made thereunto without departing from the spirit and scope of the invention as disclosed herein.

### DRAWINGS

### Crown Molding Ruler

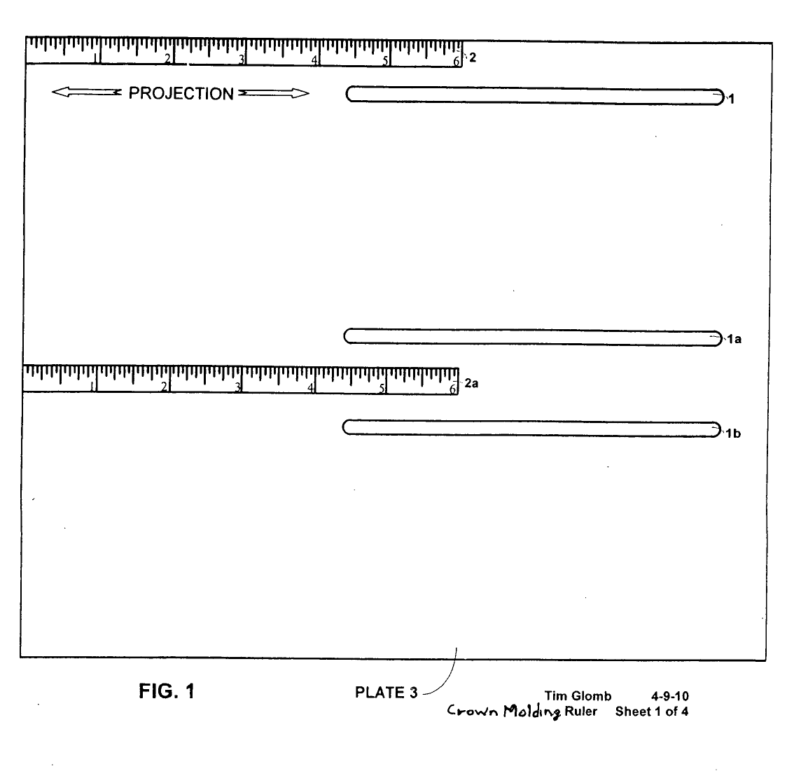

Page 1, FIG. 1 depicts a frontal view of Plate 3 of the Crown Molding Ruler.

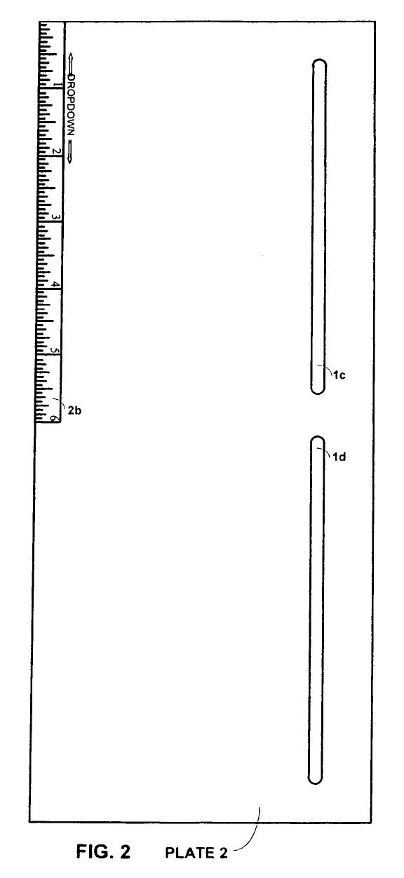

Page 2, FIG. 2 depicts a frontal view of Plate 2 of the Crown Molding Ruler.

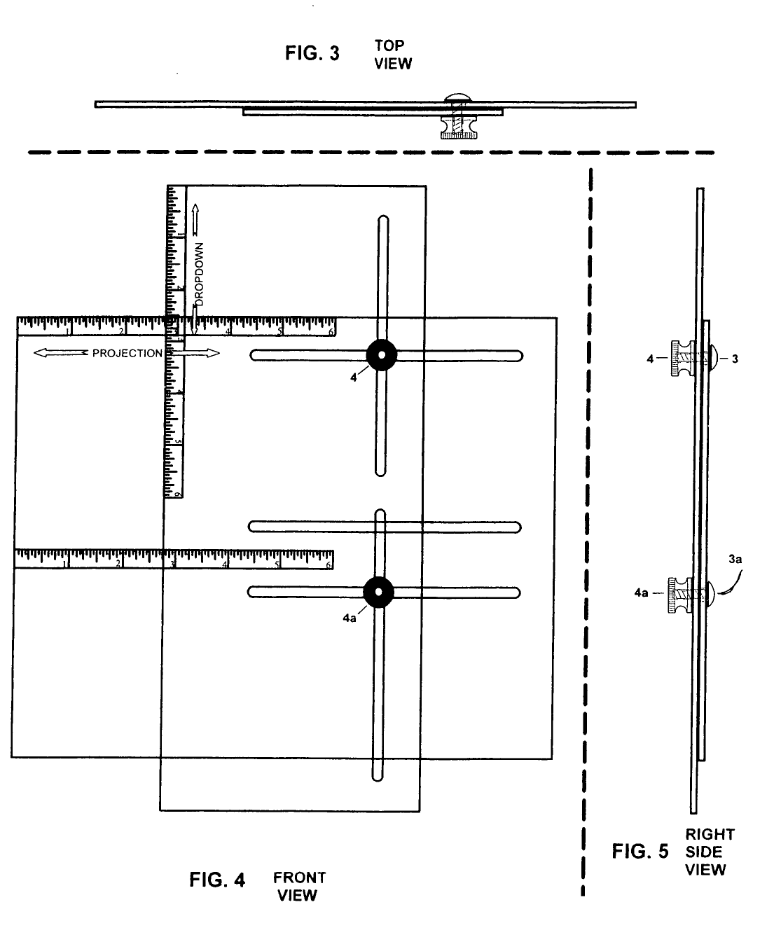

Page 3, FIG. 3, depicts a top view of the Crown Molding Ruler with both Plate 2 and Plate 3 secured together with screws and knurled nuts. FIG. 4 depicts a front view of the Crown Molding Ruler with Plate 2 overlapped on top of Plate 3 and secured together with two screws and knurled nuts. FIG. 5 depicts a right side view of the Crown Molding Ruler with both Plate 2 and Plate 3 secured together with two screws and knurled nuts.

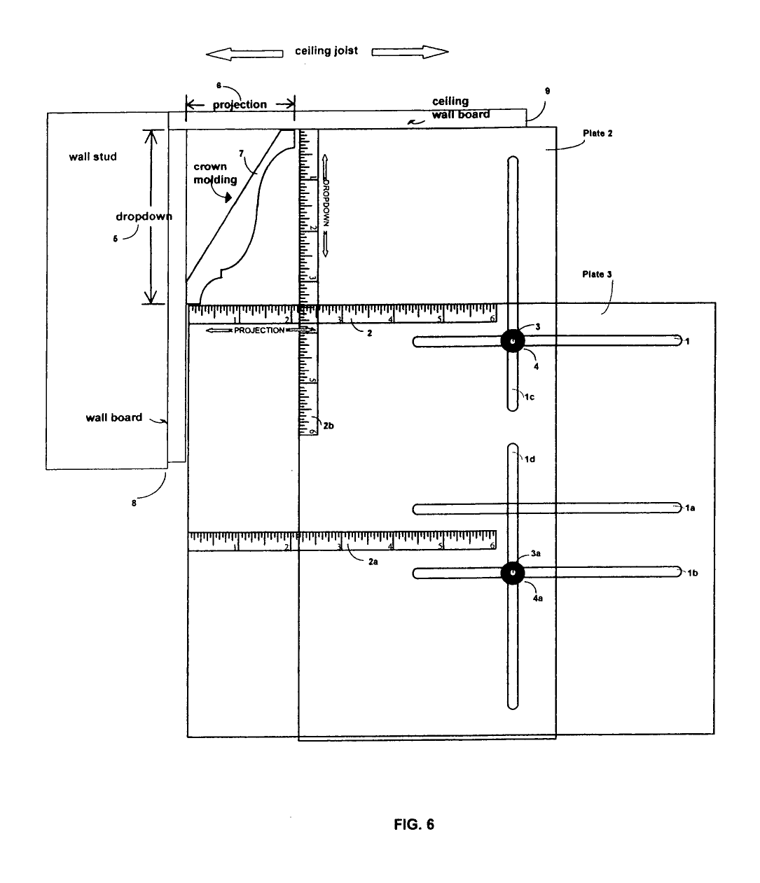

Page 4, FIG. 6 depicts the Crown Molding Ruler with Plate 2 and Plate 3 in position (against a cross section view of crown molding on the wall and ceiling) to measure the dropdown and projection dimensions

### PRIOR ART EXCERPTS

Provisional Patent Application—Crown Molding Ruler/Timothy J. Glomb, Sr.

Publication #US2008/0134531 Robinson Et Al Jun. 12, 2008

### BACKGROUND OF THE INVENTION

“The installation of crown molding is probably the most difficult task for an artisan in the building industry. The majority of crown molding is cut on a power miter saw that has compound adjustments for table and bevel cutting angles. Many saws will have marked compound angle settings for 90-degree corners. When cutting anything other than an inside or outside 90-degree corner, the worker has to calculate the compound degree settings, use a specially prepared reference table, or work by trial and error.”

“There are two types of crown molding used in the building industry with spring angles of 45 degrees and 38 degrees. The “spring angle” is the angle at which the rear face of the crown molding sits between the ceiling and the wall. A spring angle of 45 degrees extends out form the wall at an angle of 45 degrees and upward to contact the ceiling. Therefore, the distance from the wall contact of the molding to the ceiling is the same as the distance from the wall to the ceiling contact. With a spring angle of 38 degrees, the rear face of the molding extends out from the wall at an angle of 38 degrees and upwardly to contact the ceiling at a 52-degree angle. Here the distance from the wall contact of the molding to the ceiling is greater than the wall to the ceiling contact.”

“There are two systems for cutting crown molding with a miter saw. Crown molding can be cut by the “stand-up” system, with the molding oriented on the miter saw just as it will be installed against a wall. In this system, the table angle is simply set at the miter angle and there is no adjustment for bevel. Cutting accuracy suffers with the “stand-up” system.

“The “flat” system for cutting crown molding, with the molding laid flat on the saw table, involves a compound miter angle. The saw table and bevel are set at calculated values that may be derived by reference to a chart or handbook. This system is the preferred in the building industry for safety and accuracy.”

U.S. Pat. No. 7,156,008 Flip Up Multi-Mode Work Piece Stop For A Miter Saw.

This relates to a device or attachment used for positioning or securing crown molding in place on a power miter saw. I have referred to this device in my description as “crown stops”.

1) I claim the embodiment is comprised of two rectangular flat plates, “Plate 2” and “Plate 3” and fasteners.

2) Plate 2 of claim 1 shall,
a) have two slots cut through the plate inline with each other along the right side, and
b) have a linear measuring ruler along the left hand edge, beginning from the top corner, and being parallel to the slots.

3) Plate 3 of claim 1 shall,
a) have three slots cut through the plate parallel with each other, so as
1) slot 1 is parallel to top edge and long edge of plate toward right side of center, and
2) slot 2 is parallel to slot 1 along centerline of plate exactly below slot 1, and
3) slot 3 is parallel to slot 2, separated and exactly below slot 2, and
b) has a linear measuring ruler along top edge beginning from left side corner and parallel to slot 1, and
c) has a linear measuring ruler beginning from left side edge, parallel to and between slot 2 and slot 3.

4) The fasteners of claim 1 shall be a screw and nut to hold Plate 2 and Plate 3 together.
